(19) United States
(12) Patent Application Publication
(10) Pub. No.: US 2023/0219837 A1
(43) Pub. Date: Jul. 13, 2023

(54) GLASS COMPOSITION, GLASS ARTICLE PREPARED FROM THE GLASS COMPOSITION, AND DISPLAY DEVICE

(71) Applicants: Samsung Display Co., LTD., Yongin-si (KR); Kongju National University Industry University Cooperation Foundation, Gongju-si (KR)

(72) Inventors: Seung Ho KIM, Asan-si (KR); Woon Jin CHUNG, Seongnam-si (KR); Kyeong Dae PARK, Cheonan-si (KR); Min Gyeong KANG, Jinju-si (KR); Seung KIM, Seongnam-si (KR); Cheol Min PARK, Hwaseong-si (KR); Hyun Chul BAE, Yongin-si (KR); Hui Yeon SHON, Seongnam-si (KR); Gyu In SHIM, Hwaseong-si (KR); So Mi JUNG, Busan (KR); Seong Ho LEE, Suwon-si (KR)

(21) Appl. No.: 17/891,988

(22) Filed: Aug. 19, 2022

(30) Foreign Application Priority Data
Jan. 7, 2022 (KR) 10-2022-0002730

(51) Int. Cl. C03C 3/091; C03C 3/085

(52) U.S. Cl. CPC C03C 3/091; C03C 3/085

(57) ABSTRACT

A glass composition, glass article prepared from the glass composition, and display device are provided. The glass article includes, as a glass composition, about 45 to about 65 mol % of SiO₂, about 15 to about 25 mol % of Al₂O₃, about 15 to about 25 mol % of Na₂O, and 0 to about 10 mol % of B₂O₃ based on a total weight of the glass composition, where the glass composition has a thermal expansion coefficient of about 70*10⁻⁷ K⁻¹ to about 85*10⁻⁷ K⁻¹.

This application claims priority to Korean Patent Application No. 10-2022-0002730, filed on Jan. 7, 2022, and all the benefits accruing therefrom under 35 U.S.C. § 119, the content of which in its entirety is herein incorporated by reference.

### BACKGROUND

### 1. Field

The disclosure relates to a glass composition, a glass article prepared from the glass composition, and a display device.

### 2. Description of the Related Art

A glass article is widely used in building materials and an electronic device with a display device. For example, the glass article is used in the substrate and the cover window of a flat panel display device such as a liquid crystal display (“LCD”) device, an organic light-emitting diode (“OLED”) display device, an electrophoretic display device, or the like.

As a portable electronic device such as a smartphone or a tablet personal computer (“PCs”) has increasingly become widespread, the glass article used in such a portable electronic device has often been exposed to external impact. There is an increasing demand for the glass article capable of maintaining thinness for portability and properly enduring external impact.

### SUMMARY

Research has been conducted on the foldable display device for user convenience. Preferably, the glass article that is applicable to the foldable display device is thin enough to relieve bending stress when being folded and are rigid enough to withstand external impact. Accordingly, attempts have been made to improve the strength of thin glass articles by changing the composition ratio of the glass article and the conditions for the preparation of the composition of the glass article.

Aspects of the disclosure provide a glass composition having a new composition ratio, a glass article prepared from the glass composition, and a display device including the glass article.

However, aspects of the disclosure are not restricted to those set forth herein. The above and other aspects of the disclosure will become more apparent to one of ordinary skill in the art to which the disclosure pertains by referencing the detailed description of the disclosure given below.

According to an embodiment of the disclosure, a glass article includes, as a glass composition, about 45 to about 65 molar percentages (mol %) of SiO₂, about 15 to about 25 mol % of Al₂O₃, about 15 to about 25 mol % of Na₂O, and 0 to about 10 mol % of B₂O₃ based on a total weight of the glass composition, wherein the glass composition has a thermal expansion coefficient of about 70*10⁻⁷ per Kelvin (K⁻¹) to about 85*10⁻⁷ K⁻¹ and satisfies the following relations:

0.8<Al₂O₃/Na₂O (or R ratio)<1.2

where Al₂O₃/Na₂O refers to the ratio between the contents (in mol %) of Al₂O₃ and Na₂O.

The glass article may include, as the glass composition, about 55 mol % or greater of SiO₂, about 20 mol % or greater of Na₂O, and about 20 mol % or greater of Al₂O₃ and has an R ratio of about 1.0.

The glass article may do not include an alkali earth metal oxide.

The glass article may have a thickness of about 20 micrometers (μm) to about 50 μm.

The glass article may have a hardness of about 450 kilogram-force per square millimeter (kgf/mm²) to about 550 kgf/mm².

The glass article may have a density of about 2.5 grams per cubic centimeter (g/cm³) to about 2.8 g/cm³.

The glass article may have a brittleness of 4.5 μm^{-0.5} to 7.0 μm^{-0.5}.

The glass article may have a Poisson's ratio of about 0.14 to about 0.25.

The glass article may have a glass transition temperature of about 600 degrees in Celsius (° C.) to about 800° C.

The glass article may have a modulus of elasticity of about 60 gigapascals (GPa) to about 80 GPa.

The glass article may have a fracture toughness of about 0.7 MPa*m^{0.5} to about 1.0 MPa*m^{0.5}.

The glass article may have an etch rate of about 3 micrometers per minute (μm/min) to about 7 μm/min.

According to an embodiment of the disclosure, a glass composition includes about 45 to about 65 mol % of SiO₂, about 15 to about 25 mol % of Al₂O₃, about 15 to about 25 mol % of Na₂O, and 0 to about 10 mol % of B₂O₃ based on a total weight of the glass composition, where the glass composition satisfies the following relations:

0.8<Al₂O₃/Na₂O (or R ratio)<1.2

where Al₂O₃/Na₂O refers to the ratio between the contents (in mol %) of Al₂O₃ and Na₂O.

The glass composition may include about 55 mol % or greater of SiO₂, about 20 mol % or greater of Na₂O, and about 20 mol % or greater of Al₂O₃ and has an R ratio of about 1.0.

The glass composition may include about 2.5 to about 5 mol % based on the total weight of the glass composition.

The glass composition may do not include an alkali earth metal oxide.

The glass composition may do not include R₂O (where R is Li or K), other than Na₂O.

According to an embodiment of the disclosure, a display device includes a display panel including a plurality of pixels, a cover window disposed on the display panel, and an optically transparent bonding layer disposed between the display panel and the cover window, where the cover window includes, as a glass composition, about 45 to about 65 mol % of SiO₂, about 15 to about 25 mol % of Al₂O₃, about 15 to about 25 mol % of Na₂O, and 0 to about 10 mol % of B₂O₃ based on a total weight of the glass composition, has a thermal expansion coefficient of about 70*10⁻⁷ K⁻¹ to about 85*10⁻⁷ K⁻¹, and satisfies the following relations:

0.8<Al₂O₃/Na₂O (or R ratio)<1.2

where Al₂O₃/Na₂O refers to the ratio between the contents (in mol %) of Al₂O₃ and Na₂O.

The cover window may have a thickness of about 20 μm to about 50 μm.

The cover window may do not include an alkali earth metal oxide.

According to the aforementioned and other embodiments of the disclosure, a glass composition having a new composition ratio can be provided, and a glass article prepared from the glass composition can have an excellent mechanical strength and surface strength. Also, the glass article can have an excellent processability and can be flexible and strong enough to be applicable to a foldable display device.

It should be noted that the effects of the disclosure are not limited to those described above, and other effects of the disclosure will be apparent from the following description.

### BRIEF DESCRIPTION OF THE DRAWINGS

The above and other aspects and features of the disclosure will become more apparent by describing in detail embodiments thereof with reference to the attached drawings, in which:

FIG. 1 is a perspective view of glass articles according to various embodiments of the disclosure;

FIG. 2 is a perspective view of a display device having a glass article according to an embodiment of the disclosure, in its unfolded state;

FIG. 3 is a perspective view of the display device of FIG. 2 in its folded state;

FIG. 4 is a cross-sectional view of a display device having the glass article according to an embodiment of the disclosure as its cover window;

FIG. 5 is a cross-sectional view of a plate-shaped glass article according to an embodiment of the disclosure;

FIG. 6 is a graph showing the stress profile of the glass article according to an embodiment of the disclosure;

FIG. 7 is a flowchart illustrating a method of fabricating the glass article according to an embodiment of the disclosure;

FIG. 8 illustrates S2 through S6 of FIG. 7;

FIG. 9 is a graph showing the results of a pen-drop test for evaluating the impact resistance of the glass article according to an embodiment of the disclosure; and

FIG. 10 is a graph showing the results of an etch rate test for the glass article according to an embodiment of the disclosure.

### DETAILED DESCRIPTION

The invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

It will also be understood that when a layer is referred to as being “on” another layer or substrate, it can be directly on the other layer or substrate, or intervening layers may also be present. The same reference numbers indicate the same components throughout the specification.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the invention. Similarly, the second element could also be termed the first element.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Hereinafter, embodiments will be described with reference to the accompanying drawings.

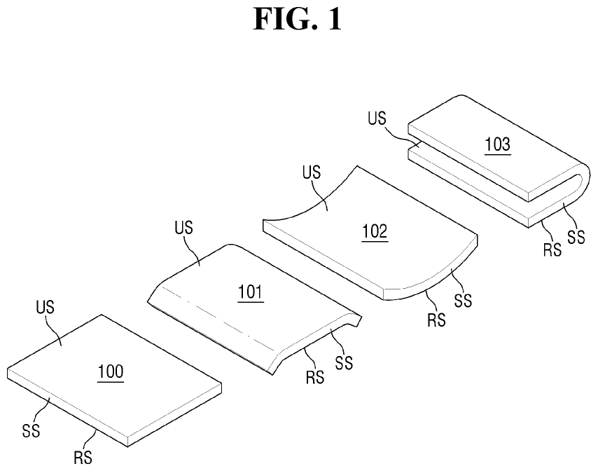

FIG. 1 is a perspective view illustrating glass articles according to various embodiments of the disclosure.

Glass is used not only in tablet personal computers (PCs), notebook computers, smartphones, electronic book readers, televisions (TVs), or PC monitors, but also in electronic devices (such as refrigerators or washing machines) including display devices. Glass may be used in cover windows, display or touch panels, or optical members such as light guide plates. Glass may also be used in cover glasses for automobile instrument panels, cover glasses for solar cells, building interior materials, and the windows of buildings or houses.

Some glass is desirable to have a certain range of a strength. For example, it is preferable that glass for use in windows is sufficiently thin to achieve high transmittance and light weight, and is strong enough not to be easily broken by external impact. Strengthened glass can be produced by chemical strengthening or thermal strengthening. Examples of various shapes of strengthened glass are illustrated in FIG. 1.

Referring to FIG. 1, a glass article 100 may be in the shape of a flat sheet or a flat plate, and glass articles 101, 102, and 103 may have a three-dimensional (“3D”) shape including curved parts. For example, the glass article 101 may include a flat portion with curved edges, the glass article 102 may be generally curved, and the glass article 103 may be folded. Alternatively, the glass article 100 may be in the shape of a flat sheet or a flat plate and may be flexible such as foldable, stretchable, or rollable. Each of the glass articles 101, 102, and 103 may have a first surface US, a second surface RS, and side surfaces SS.

The glass articles 100 through 103 may have a rectangular shape in a plan view, but the disclosure is not limited thereto. Alternatively, the glass articles 100 through 103 may have various other shapes such as a rectangular shape with rounded corners, a square shape, a circular shape, or an elliptical shape. Glass articles according to embodiments of the disclosure will hereinafter be described as being flat plates having a rectangular shape in a plan view, but the disclosure is not limited thereto.

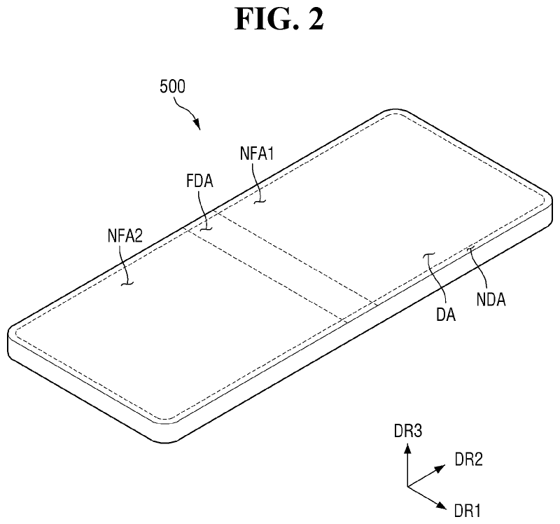

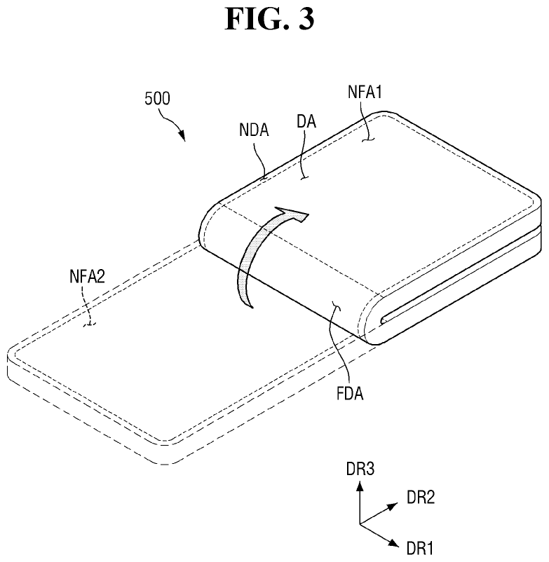

FIG. 2 is a perspective view of a display device having a glass article according to an embodiment of the disclosure, in its unfolded state. FIG. 3 is a perspective view of the display device of FIG. 2 in its folded state.

Referring to FIGS. 2 and 3, a display device 500 may be a foldable display device. As will be described later, the display device 500 may include the glass article 100 of FIG. 1 as a cover window, and the glass article 100 may have flexibility and may thus be foldable.

A first direction DR1 may be a direction parallel to one side (e.g., short side) of the display device 500 in a plan view, for example, a horizontal direction of the display device 500. A second direction DR2 may be a direction parallel to another side (e.g., long side) of the display device 500 that meets the one side of the display device 500, for example, a vertical direction of the display device 500. A third direction DR3 may be the thickness direction of the display device 500.

The display device 500 may have a rectangular shape in a plan view. The display device 500 may have a rectangular shape with right-angled or rounded corners, in a plan view. The display device 500 may have two short sides arranged in the first direction DR1 and two long sides arranged in the second direction DR2, in a plan view.

The display device 500 may include a display area DA and a non-display area NDA. In a plan view, the shape of the display area DA may correspond to the shape of the display device 500. For example, in a case where the display device 500 has a rectangular shape in a plan view, the display area DA may also have a rectangular shape in a plan view.

The display area DA may be an area that includes a plurality of pixels and can thus display an image. The pixels may be arranged in a matrix. The pixels may have a rectangular, rhombus, or square shape in a plan view, but the disclosure is not limited thereto. Alternatively, the pixels may have a tetragonal shape other than a rectangular, rhombus, or square shape, a non-tetragonal polygonal shape, a circular shape, or an elliptical shape in a plan view.

The non-display area NDA may be an area that does not include the pixels and thus does not display an image. The non-display area NDA may be disposed around the display area DA. The non-display area NDA may be disposed to surround the display area DA, but the disclosure is not limited thereto. The display area DA may be surrounded in part by the non-display area NDA.

The display device 500 may be able to maintain to be folded or unfolded. The display device 500 may be folded in such that the display area DA may be positioned on the inside of the display device 500, as illustrated in FIG. 3. When folded in, parts of the top surface of the display device 500 may be arranged to face each other. Alternatively, the display device 500 may be folded out such that the display area DA may be positioned on the outside of the display device 500. When folded out, parts of the bottom surface of the display device 500 may be arranged to face each other.

The display device 500 may be a foldable device. As used herein, the term “foldable device”, which is a device capable of being folded, refers to a device may be in both a folded state and an unfolded state as well as a device only be in a folded state. The term “folded” encompasses being folded at an angle of about 180 degrees)(°, but the disclosure is not limited thereto. Even when folded at an angle of more than 180° or less than 180°, for example, at an angle of 90° to 180° or 120° to 180°, the display device 500 may be understood as being folded. Also, even when not completely folded, the display device 500 may be referred to as being in a folded state if the display device is bent out of an unfolded state. For example, even when bent at an angle of 90° or less, the display device 500 may be referred to as being in the folded state to distinguish such state from the unfolded state. When the display device 500 is folded, the curvature radius of the display device 500 may be about 5 millimeters (mm) or less, preferably about 1 mm to about 2 mm or about 1.5 mm, but the disclosure is not limited thereto.

The display device 500 may include a folding area FDA, a first non-folding area NFA1, and a second non-folding area NFA2. The folding area FDA may be an area where the display device 500 is folded, and the first and second non-folding areas NFA1 and NFA2 may be areas where the display device 500 is not folded.

The first non-folding area NFA1 may be disposed on one side of the folding area FDA, for example, on the upper side of the folding area FDA. The second non-folding area NFA2 may be disposed on the other side of the folding area FDA, for example, on the lower side of the folding area FDA. The folding area FDA may be an area that is curved with a predetermined curvature.

The location of the folding area FDA in the display device 500 may be fixed. One or more two fixed folding areas FDA may be provided in the display device 500. Alternatively, the location of the folding area FDA in the display device 500 may not be fixed, but the folding area FDA may be set at various locations.

The display device 500 may be folded in the second direction DR2. Accordingly, the length, in the second direction DR2, of the display device 500 can be reduced by half so that it can be convenient for a user to carry around the display device 500.

The direction in which the display device 500 is folded is not particularly limited. Alternatively, the display device 500 may be folded in the first direction DR1. In this case, the length, in the first direction DR1, of the display device 500 can be reduced by half.

The display area DA and the non-display area NDA are illustrated as overlapping with the folding area FDA, the first non-folding area NFA1, and the second non-folding area NFA2, but the disclosure is not limited thereto. Alternatively, the display area DA and the non-display area NDA may overlap with at least one of the folding area FDA, the first non-folding area NFA1, and the second non-folding area NFA2.

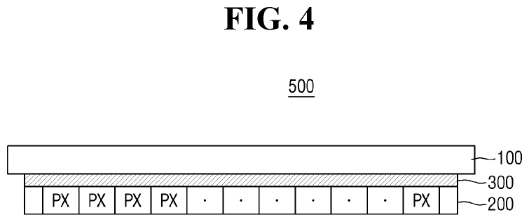

FIG. 4 is a cross-sectional view of a display device having the glass article 100 as its cover window.

Referring to FIG. 4, the display device 500 may include a display panel 200, the glass article 100, which is disposed on the display panel 200 and serves as a cover window, and an optically transparent bonding layer 300, which is disposed between the display panel 200 and the glass article 100 to couple the display panel 200 and the glass article 100.

The display panel 200 may include, for example, a light-emitting display panel such as an organic light-emitting diode (OLED) display panel, an inorganic electroluminescent (“EL”) display panel, a quantum dot light-emitting diode (“QLED”) display panel, a micro light-emitting diode (“micro-LED”) display panel, a nano light-emitting diode (“nano-LED”) display panel, a plasma display panel (“PDP”), a field emission display (“FED”) panel, or a cathode-ray tube (“CRT”) display panel or a light-receiving display panel such as a liquid crystal display (LCD) panel, an electrophoretic display (“EPD”) panel.

The display panel 200 may include a plurality of pixels PX and may display an image using light emitted from the pixels PX. The display device 500 may further include a touch member (not illustrated). For example, the touch member may be incorporated into the display panel 200. For example, the touch member may be formed directly on a display member of the display panel 200 so that the display panel 200 can perform a touch function. In another example, the touch member may be fabricated separately from the display panel 200 and may be attached to the top surface of the display panel 200 via the optically transparent bonding layer 300.

The glass article 100, which protects the display panel 200, is disposed above the display panel 200. The glass article 100 may be larger in size than the display panel 200 and may thus protrude beyond the sides of the display panel 200, but the disclosure is not limited thereto. The display device 500 may include a printed layer (not illustrated), which is disposed on at least one surface of the glass article 100 on the edges of the glass article 100. The printed layer may prevent the bezel of the display device 500 from becoming visible from the outside of the display device 500 and may perform a decorative function.

The optically transparent bonding layer 300 is disposed between the display panel 200 and the glass article 100. The optically transparent bonding layer 300 fixes the glass article 100 onto the display panel 200. The optically transparent bonding layer 300 may include an optically clear adhesive (“OCA”) or an optically clear resin (“OCR”).

The glass article 100 of FIG. 4 will hereinafter be described in detail.

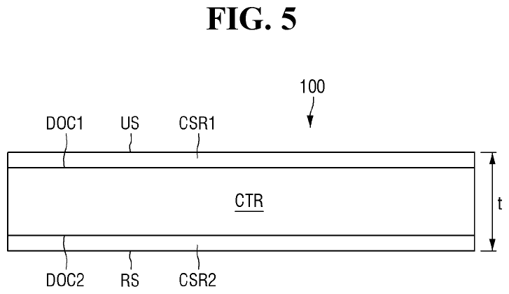

FIG. 5 is a cross-sectional view of the glass article according to an embodiment of the disclosure, which is plate-shaped.

Referring to FIG. 5, the glass article 100 may include a first surface US, a second surface RS, and side surfaces. The first and second surfaces US and RS of the glass article 100 are main surfaces that have a large area, and the side surfaces of the glass article 100 may be outer surfaces that connect the first and second surfaces US and RS.

The first and second surfaces US and RS are opposite to each other in a thickness direction. In a case where the glass article 100, like a cover window, transmits light therethrough, light may enter one of the first and second surfaces US and RS and may exit through the other surface.

A thickness of the glass article 100 is defined as the distance between the first and second surfaces US and RS. The thickness t of the glass article 100 may be in the range of about 20 μm to about 100 μm, but the disclosure is not limited thereto. For example, the thickness t of the glass article 100 may be about 80 μm or less. In another example, the thickness t of the glass article 100 may be about 75 μm or less. In another example, the thickness t of the glass article 100 may be about 70 μm or less. In another example, the thickness t of the glass article 100 may be about 60 μm or less. In another example, the thickness t of the glass article 100 may be about 65 μm or less. In another example, the thickness t of the glass article 100 may be about 50 μm or less. In another example, the thickness t of the glass article 100 may be about 30 μm or less. In some embodiments, the thickness t of the glass article 100 may be in the range of about 20 μm to about 50 μm or may be about 30 μm. The glass article 100 may have a uniform thickness t or may have different thicknesses t from one location to another location.

The glass article 100 may be strengthened to have a predetermined stress profile. Once strengthened, the strengthened glass article 100 can better prevent breakage and the occurrence and propagation of cracks that may be caused by external impact. The strengthened glass article 100 may have different stresses in different parts thereof. For example, compressive regions (CSR1 and CSR2) in which compressive stress acts may be provided near the surfaces of the glass article 100, i.e., near the first and second surfaces US and RS, and a tensile region CTR in which tensile stress acts may be provided on the inside of the glass article 100. The stress at the boundaries between the tensile region CTR and the compressive regions (CSR1 and CSR2) may be zero. The compressive stress in each of the compressive regions (CSR1 and CSR2) may vary depending on the location (i.e., the depth from the first or second surface US or RS). Also, the stress in the tensile region CTR may vary depending on the depth from the first or second surface US or RS.

The mechanical properties of the glass article 100 such as surface strength may be considerably affected by the locations of the compressive regions (CSR1 and CSR2) in the glass article 100, the stress profiles in the compressive regions (CSR1 and CSR2), the compressive energy of the compressive regions (CSR1 and CSR2), or the tensile energy of the tensile region CTR.

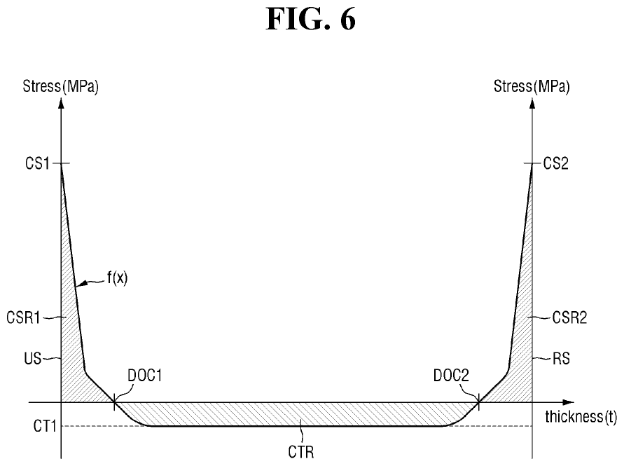

FIG. 6 is a graph showing the stress profile of a glass article according to an embodiment of the disclosure. Referring to FIG. 6, an X axis represents the thickness direction of the glass article 100, and a Y axis represents Stress with unit of megapascals “MPa”. In the graph of FIG. 6, compressive stress is represented as a positive value, and tensile stress is represented as a negative value. However, the magnitude of the compressive/tensile stress is represented by the absolute value of the compressive/tensile stress.

Referring to FIG. 6, the glass article 100 includes a first compressive region CSR1, which extends (or expands) to a first compression depth DOC1 from the first surface US, and a second compressive region CSR2, which extends (or expands) to a second compression depth DOC2 from the second surface RS. A tensile region CTR is disposed between the first and second compression depths DOC1 and DOC2. In the stress profile in the glass article 100, compressive/tensile regions between the first and second surfaces US and RS of the glass article 100 may be symmetrical with respect to the center of the thickness t. Although not specifically illustrated in FIG. 6, compressive/tensile regions may be arranged between the sides of the glass article 100 in a similar manner to those between the first and second surfaces US and RS of the glass article 100.

The first and second compressive regions CSR1 and CSR2 prevents the glass article 100 from cracking or breaking due to external impact. As maximum compressive stresses CS1 and CS2 of the first and second compressive regions CSR1 and CSR2 increase, the strength of the glass article 100 generally increases. Since external impact is generally delivered through the surfaces of the glass article 100, it is advantageous, in terms of durability, that the glass article 100 has the maximum compressive stresses CS1 and CS2 at the surfaces thereof. The compressive stresses of the first and second compressive regions CSR1 and CSR2 tend to decrease in a direction from the surfaces to the inside of the glass article 100.

The first and second compression depths DOC1 and DOC2 suppresses the propagation of cracks or indentations formed on the first and second surfaces US and RS into the tensile region CTR inside the glass article 100. The greater the first and second compression depths DOC1 and DOC2, the better the suppression of the propagation of cracks. Locations corresponding to the first and second compression depths DOC1 and DOC2 correspond to the boundaries between the tensile region CTR and the first and second compression regions CSR1 and CSR2, and the stress at the first and second compression depths DOC1 and DOC2 is zero.

The tensile stress of the tensile region CTR may be balanced with the compressive stresses of the first and second compression regions CSR1 and CSR2 throughout the glass article 100. That is, the sum of compressive stresses (i.e., compressive energy) in the glass article 100 may be the same as the sum of tensile stresses (i.e., tensile energy) in the glass article 100. Stress energy accumulated in one region in the glass article 100 with a uniform thickness in the thickness direction of the glass article 100 may be calculated by integrating the stress profile of the glass article 100, as indicated by Equation (1):

∫₀^{t}f(x)dx=0 (1)

where f(x) denotes the stress profile of the glass article 100, which has the thickness t.

As the magnitude of the tensile stress in the glass article 100 increases, there is an increasing risk of the glass article 100 breaking violently into fragments and being crushed from the inside out. A maximum tensile force CT1 that satisfies the fragility criterion of the glass article 100 may satisfy, but is not limited to, Equation (2):

CT1≤−38.7×ln(t)+48.2 (2).

In some embodiments, the maximum tensile force CT1 may be about 100 MPa or less or about 85 MPa or less. The maximum tensile force CT1 may preferably be about 75 MPa or greater to improve the mechanical characteristics (such as strength) of the glass article 100. For example, the maximum tensile force CT1 may be about 75 MPa to about 85 MPa, but the disclosure is not limited thereto.

The maximum tensile force CT1 may be located at the center, in the thickness direction, the glass article 100. For example, the maximum tensile force CT1 may be located at a depth of about 0.4 t to about 0.6 t, about 0.45 t to about 0.55 t, or about 0.5 t.

In order to improve the strength of the glass article 100, the maximum compressive stresses CS1 and CS2 and the first and second compression depths DOC1 and DOC2 may preferably be large. However, as compressive energy increases, tensile energy and the maximum tensile force CT1 may both increase. In order to achieve high strength and meet the fragility criterion of the glass article 100, the stress profile of the glass article 100 may preferably be adjusted such that the maximum compressive stresses CS1 and CS2 and the compression depths DOC1 and DOC2 can become as large as possible, but the compressive energy can decrease. The glass article 100 can be prepared from a glass composition including particular amounts of particular ingredients, and can have an excellent strength and a suitable flexibility and physical properties for being applied to a foldable display device, depending on the composition ratio of the ingredients of the glass composition.

In an embodiment, for example, the glass composition may contain about 45 to about 65 mol % of SiO₂, about 15 to about 25 mol % of Al₂O₃, about 15 to about 25 mol % of Na₂O, 0 to about 10 mol % of B₂O₃, and 0 to about 10 mol % of P₂O₅. Here, the expression “0 mol % of a particular ingredient”, as used herein, means that the particular ingredient is substantially not contained, which also means that the particular ingredient is not intentionally included as a raw material and encompasses a case where very small amounts of impurities (for example, less than 0.1 mol %) are contained inevitably or accidentally.

The ingredients of the glass composition will hereinafter be described. SiO₂, which constitutes the skeleton of glass, may improve the chemical durability of the glass article 100 and may reduce the generation of cracks when scratches (or indentations) are formed on the surface of the glass article 100. SiO₂ may be a network former oxide, and a glass article 100 containing SiO₂ can have a lowered thermal expansion coefficient and improved mechanical strength. To this end, SiO₂ may be contained in an amount of about 60 mol % or greater. For sufficient meltability, SiO₂ may be contained in the glass composition in an amount of 65 mol % or less.

Al₂O₃ improves the crushability of glass. That is, Al₂O₃ helps glass break into fewer pieces. Al₂O₃ may be an intermediate oxide forming a bond with SiO₂, which is a network former. Also, Al₂O₃ may improve the performance of ion exchange during chemical strengthening and may increase the surface compressive stress of the glass article 100 after strengthening. If Al₂O₃ is contained in an amount of about 15 mol % or greater, it may serve as an effective ingredient for increasing the surface compressive stress of the glass article 100 after strengthening. To maintain the acid resistance and the meltability of the glass article 100, the content of Al₂O₃ in the glass composition may preferably be about 25 mol % or less.

B₂O₃ improves the chipping resistance and the meltability of glass. B₂O₃, like SiO₂, may be a network former oxide. B₂O₃ may be omitted (or contained in an amount of 0 mol %), but can further improve the meltability of the glass article 100 when contained in an amount of about 0.5 mol % or greater. The content of B₂O₃ may preferably be about 10 mol % or less to suppress the occurrence of striae during melting. The glass composition may contain about 2.5 mol % or greater or about 5 mol % or greater of B₂O₃ to secure sufficient chipping resistance and meltability for the glass article 100.

P₂O₅ improves the performance of ion exchange and the chipping resistance of glass. P₂O₅, like SiO₂, may be a network former oxide. B₂O₃ may be omitted (or contained in an amount of 0 mol %), but can significantly improve the performance of ion exchange and the chipping resistance of the glass article 100 when contained in an amount of about 0.5 mol % or greater. The content of P₂O₅ may preferably be 10 mol % or less for preventing significant decreases in crushability and acid resistance and may more preferably be about 5 mol % or less for preventing decreases in the stability, crushability, and acid resistance of the glass article 100.

Na₂O forms surface compressive stress through ion exchange and improves the meltability of glass. Na₂O may form non-crosslinked oxygen in a SiO₂ network structure by forming ionic bonds with the oxygen of SiO₂, which is a network former. The non-crosslinked oxygen can improve the flexibility of the SiO₂ network structure and can allow the glass article 100 to be suitable for use in a foldable display device. To this end, Na₂O may preferably be contained in an amount of 15 mol % or greater. The content of Na₂O may preferably be 25 mol % or less in terms of the acid resistance of the glass article 100.

The glass composition may contain 15 mol % or greater, or 20 mol % or greater, of Na₂O and may satisfy Relation (1):

0.8<Al₂O₃/Na₂O (or R ratio)<1.2

where Al₂O₃/Na₂O refers to the ratio between the contents (in mol %) of Al₂O₃ and Na₂O.

As already mentioned above, the glass article 100 prepared from the glass composition may have suitable physical properties for being applied to a foldable display device. For example, the glass article 100 may be flexible enough to be folded or unfolded and may have suitable strength and chemical properties for being applied to the display device 500 as a cover window. A flexible network structure may be obtained by adding Na₂O to a network structure formed of SiO₂, B₂O₃, P₂O₅, and Al₂O₃. Due to the addition of Na₂O, Na ions form ionic bonds with oxygen between network-forming bonds, for example, between SiO₂ bonds, so that non-crosslinked oxygen may increase. An increase in the non-crosslinking oxygen in the network structure means that the bonds in the network structure are broken or become open, and the network structure of glass may become flexible. The glass composition may include 15 mol % or more, or about 20 mol % or more, of Na₂O so that the glass article 100 may have sufficient flexibility.

As the glass composition contains a relatively large amount of Na₂O, the mechanical strength of the glass article 100 may be weak. To address this, the glass composition may also contain Al₂O₃, and mechanical strength can be added to the network structure of the glass article 100 by controlling the content ratio of Al₂O₃ to Na₂O to range between 0.8 to 1.2, as indicated by Relation (1). The Al₂O₃-to-Na₂O content ratio (or the R ratio) of the glass composition may be 0.8 to 1.2 or may be about 1.

As the Al₂O₃-to-Na₂O content ratio (or the R ratio) of the glass composition is close to 1, Al₂O₃ may have a tetrahedral crystal structure formed by SiO₂. In the network structure formed by SiO₂, SiO₂ may have a tetrahedral crystal structure ([SiO₄]). When Na₂O and Al₂O₃ are contained in the same content, Al₂O₃ may also have a tetrahedral crystal structure ([AlO₄]). In this case, the content of non-crosslinked oxygen formed due to the addition of Na₂O may decrease, and the ion mobility of the glass composition may increase. An increase in ion mobility means an increase in the amount of ions moving during chemical strengthening during the formation of the glass article 100 and an increase in the penetration depth of ions, and the mechanical strength of the glass article 100 may be improved.

In a case where the Al₂O₃-to-Na₂O content ratio (or the R ratio) of the glass composition is greater than 1, Al₂O₃ may have an octahedral crystal structure, rather than a tetrahedral crystal structure. In the octahedral crystal structure ([AlO₆]) formed by Al₂O₃, ion mobility may decrease due to a blocking effect, and the amount of non-crosslinked oxygen may decrease due to the addition of Na₂O. In a case where the Al₂O₃-to-Na₂O content ratio (or the R ratio) of the glass composition is less than 1, the amount of non-crosslinked oxygen may further increase due to the addition of Na₂O, but ion mobility may decrease due to the blocking effect by Al ions. That is, the closer the Al₂O₃-to-Na₂O content ratio (or the R ratio) of the glass composition is to 1, the glass article 100 may have not only flexibility, but also sufficient strength against external impact.

The glass composition may further include Y₂O₃, La₂O₃, Nb₂O₅, Ta₂O₅, and Gd₂O₃. The glass composition may further include Sb₂O₃, CeO₂, and/or As₂O₃ as a clarifier.

The glass composition may further contain R₂O (where R is Li or K) in addition to Na₂O to promote ion exchange during chemical strengthening. However, in an embodiment, as the glass composition includes a relatively large amount of Na₂O, the glass composition may not contain at least K₂O as R₂O. Only one chemical strengthening process may be performed during the formation of the glass article 100, and the glass composition may not contain K₂O such that a large amount of Na ions may move over the surface of the glass article 100 during the chemical strengthening process when ion exchange takes place. In another embodiment, the glass composition may not contain R₂O except for Na₂O. That is, the glass composition may contain neither Li₂O nor K₂O.

In an embodiment, the glass composition may not contain an alkali earth metal oxide (i.e., RO where R is an alkali earth metal). The alkali earth metal oxide may be, for example, MgO, CaO, SrO, or BaO. The alkali earth metal oxide may improve the surface strength of the glass article 100 when contained in the glass composition. As the glass article 100 contains a large amount of Na₂O so that the R ratio of the glass article 100 is 0.8 to 1.2 or about 1, the glass article 100 may have sufficient flexibility and mechanical strength, but the alkali earth metal oxide may adversely affect the flexibility and moldability of the glass article 100.

In an embodiment, for example, the glass article 100 may be molded into various shapes or sizes to be applicable to the cover window of the display device 500. However, when the glass article 100 is too mechanically strong, the glass article 100 may not be able to be easily molded, and an excessive molding of the glass article 100 may result in a degraded surface quality. In an embodiment, as the glass composition does not contain an alkali earth metal oxide, but contains particular amounts of Na₂O and Al₂O₃, the glass article 100 can have both flexibility and excellent mechanical strength and can provide excellent processability and moldability.

The glass composition may be molded into the form of plate glass by various methods well known in the art to which the disclosure pertains. Once the glass composition is molded into the form of plate glass, the plate glass may be processed into the glass article 100, which is applicable to the display device 500, but the disclosure is not limited thereto. Alternatively, the glass composition may be directly molded into the glass article 100 without an additional molding process.

It will hereinafter be described how to prepare plate glass from the glass composition and to process the plate glass into the glass article 100.

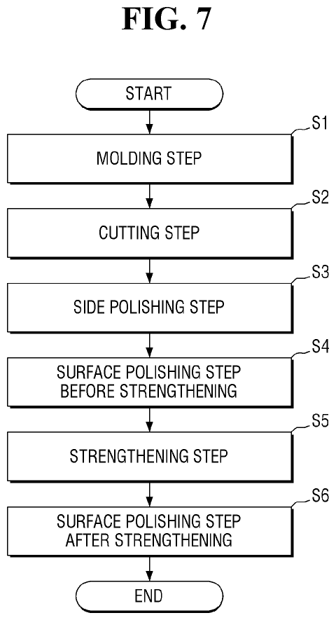

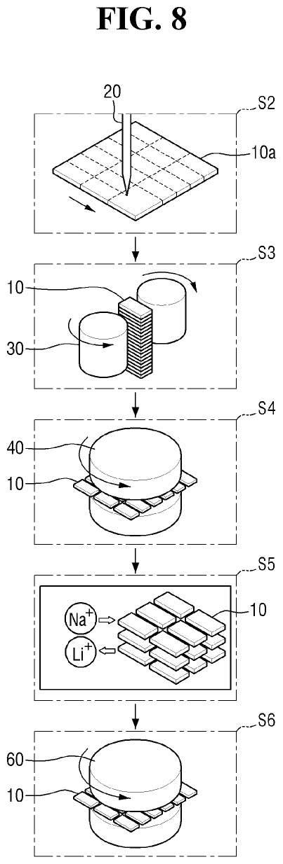

FIG. 7 is a flowchart illustrating a method of fabricating the glass article according to an embodiment of the disclosure. FIG. 8 illustrates S2 through S6 of FIG. 7.

Referring to FIGS. 7 and 8, the method may include a molding step (S1), a cutting step (S2), a side polishing step (S3), a pre-strengthening surface polishing step (S4), a strengthening step (S5), and a post-strengthening surface polishing step (S6).

S1 may include preparing a glass composition and molding the glass composition. The composition ratio and the ingredients of the glass composition are as already described above, and thus, detailed descriptions thereof will be omitted. The glass composition may be molded into the form of plate glass by a float method, a fusion draw method, or a slot draw method.

In S2, the plate glass may be cut. The plate glass may have a different size from a final glass article. For example, the glass composition may be molded into a mother glass substrate 10a, and the mother glass substrate 10a may be cut into a plurality of glass cells 10, thereby fabricating a plurality of glass articles. For example, if the final glass article has a size of about 6 inches, the glass composition may be molded into a mother glass substrate 10a having a much larger size than the final glass article, for example, a size of 120 inches, and the mother glass substrate 10a may be cut into 20 glass cells 10 having the size of the final glass article. In this manner, the efficiency of fabrication can be improved, as compared to a case where the plurality of glass articles 100 are formed separately through molding. Also, even if the glass composition is molded into a single individual glass cell 10 for a single glass article 100, the individual glass cell 10 may be cut into any desired shape according to the shape of the glass article 100.

The cutting of the mother glass substrate 10a may be performed using a cutting knife 20, a cutting wheel, or laser.

S2 may be performed before S5. The mother glass substrate 10a may be strengthened as a whole and may then be cut into the size of the final glass article. In this case, however, the cut sides of each of the glass cells 10 (e.g., the sides of each of the glass cells 10) may not be strengthened. Thus, it may be preferable that S5 is performed after S2.

S4 may be performed between S2 and S5. A polishing process may include S3 and S4. S3 may be performed, and then S4 may be performed. Alternatively, S4 may be performed, and then S3 may be performed.

S3 is a step of polishing the sides of each of the glass cells 10. In S3, the sides of each of the glass cells 10 are polished to be smooth and even. Specifically, each of the glass cells 10 may have one or more cut sides. Some of the glass cells 10 may have two cut sides out of four sides, some of the glass cells 10 may have three cut sides out of four sides, and some of the glass cells 10 may have all four sides cut. Cut sides and non-cut sides of each of the glass cells 10 may have different surface roughnesses, and even the cut sides of each of the glass cells 10 may have different surface roughnesses. As the sides of each of the glass cells 10 are polished in S3, the sides of each of the glass cells 10 may have uniform surface roughness. Also, any cracks on the sides of each of the glass cells 10 may be removed in S3.

S3 may be performed on all the glass cells 10 at the same time. That is, the glass cells 10 may be stacked and may then be polished at the same time.

S3 may be performed by mechanical polishing or chemical mechanical polishing (“CMP”) using polishing equipment 30. Two opposite sides of each of the glass cells 10 may be polished at the same time, and the other two opposite sides of each of the glass cells 10 may be polished at the same time. However, the disclosure is not limited to this.

S4 may be performed such that each of the glass cells 10 may have uniform surfaces. S4 may be performed on each of the glass cells 10 separately. If CMP equipment 40 is much larger than the glass cells 10, the glass cells 10 may be arranged horizontally and may then be polished at the same time by the CMP equipment 40.

S4 may be performed by CMP. Specifically, first and second cut surfaces of each of the glass cells 10 are polished using the CMP equipment 40 and a polishing slurry. The first and second surfaces of each of the glass cells 10 may be polished at the same time or may be polished one after another.

S5 is performed after S4. S5 may be performed by chemical strengthening and/or thermal strengthening. In a case where the glass cells 10 have a thickness of 2 mm or less or 0.75 mm or less, chemical strengthening may be suitable for precisely controlling the stress profile of the glass cells 10.

S6 may be further performed after S5. S6 may remove any fine cracks on the surfaces of each of the strengthened glass cells 10 and may control compressive stress on the first and second surfaces of each of the strengthened glass cells 10. For example, a float method, which is a method of fabricating plate glass, is performed by pouring the glass composition into a tin bath. In this example, surfaces in contact with the tin bath may have a different composition from surfaces not in contact with the tin bath. Accordingly, after S5, deviations in compressive stress may occur between the surfaces in contact with the tin bath and the surfaces not in contact with the tin bath. Such compressive stress deviations can be reduced by polishing the surfaces of each of the glass cells 10 to an appropriate thickness.

S6 may be performed by CMP. Specifically, the first and second surfaces of each of the strengthened glass cells 10 are polished using CMP equipment 60 and a polishing slurry. Each of the strengthened glass cells 10 may be polished by a thickness of about 100 nanometers (nm) to about 1000 nm, but the disclosure is not limited thereto. The first and second surfaces of each of the strengthened glass cells 10 may be polished by the same thickness or different thicknesses.

Although not specifically illustrated, a shape forming step may be further performed after S6. For example, three-dimensional (3D) processing for forming 3D glass articles (see “101” through “103”) may be performed after S6.

A glass article 100 obtained from the glass composition may have a similar composition ratio to the glass composition. For example, the glass article 100 may contain about 45 to about 65 mol % of SiO₂, about 15 to about 25 mol % of Al₂O₃, about 15 to about 25 mol % of Na₂O, 0 to about 10 mol % of B₂O₃, and 0 to about 10 mol % of P₂O₅. The glass article 100 may contain about 2.5 mol % or more, or about 5 mol % or more, of B₂O₃. The glass article 100 obtained by the method of FIG. 7 may contain about 15 mol % or more, or about 20 mol % or more, of Na₂O, and the glass composition may satisfy Relation (1):

0.8<Al₂O₃/Na₂O (or R ratio)<1.2

where Al₂O₃/Na₂O refers to the ratio between the contents (in mol %) of Al₂O₃ and Na₂O.

The glass article 100 may not include R₂O (where R is Li or K) except for Na₂O. That is, the glass article 100 may not include K₂O or both Li₂O and K₂O. The glass article 100 obtained by the method of FIG. 7 may not include an alkali earth metal oxide (i.e., RO where R is an alkali earth metal).

The glass article 100 may have an etch rate (ER) of about 3 μm/min to about 7 μm/min with respect to an etchant. The glass article 100 may be flexible and strong enough to be applicable to, for example, a foldable display device 500, and may have a physical property for being able to be easily molded. As already mentioned above, even if the glass composition does not include an alkali earth metal oxide, the glass article 100 can have sufficient mechanical strength to be applied to a foldable display device 500 because it is prepared from the glass composition with a relatively large amount of Na₂O. As the glass article 100 does not contain an alkali earth metal oxide, the glass article 100 can have an excellent etch rate with respect to an etchant, and the processability of the glass article 100 for a shape-forming process can be improved. Also, as the glass article 100 can have an excellent etch rate, the amount of time that it takes to mold the glass article 100 can be reduced, and any surface damage that may be caused during the molding of the glass article 100 can be prevented.

The glass article 100 may have an etch rate of about 4 μm/min to about 6 μm/min with respect to an etchant. For example, the glass article 100 may have an etch rate of about 5 μm/min or greater with respect to an etchant. An etchant for use in the molding of the glass article 100 may include a fluorine-based etchant. For example, the etchant for use in the molding of the glass article 100 may be any one of a hydrogen fluoride (HF)-based etchant, an ammonium hydrogen fluoride (NH₄HF₂)-based etchant, and an ammonium bifluoride (NH₄F₂)-based etchant. Also, in some embodiments, the etchant for use in the molding of the glass article 100 may further include hydrochloric acid (HCl), sulfuric acid (H₂SO₄), nitroxyl (HNO), or ultrapure water as an additive to the fluorine-based etchant.

The glass article 100 may have a thickness of about 20 μm to about 50 μm and may satisfy the following physical properties:
i) Thermal Expansion Coefficient: about 70*10⁻⁷/K to about 85*10⁻⁷/K;
ii) Hardness: about 450 kgf/mm² to about 550 kgf/mm²;
iii) Density: about 2.5 g/cm³ to about 2.8 g/cm³;
iv) Brittleness: about 4.5 μm^{-0.5} to about 7.0 μm^{-0.5};
v) Poisson's Ratio: about 0.14 to about 0.25;
vi) Glass Transition Temperature (Tg): about 600° C. to about 800° C.;
vii) Modulus of Elasticity: about 60 GPa to about 80 GPa; and
vii) Fracture Toughness: about 0.7 MPa*m^{0.5} to about 1.0 MPa*m^{0.5}.

Preparation and experimental examples of the glass article according to an embodiment of the disclosure will hereinafter be described.

### Preparation Example 1: Preparation of Glass Articles

Multiple glass substrates having various compositions were prepared, and glass articles “SAMPLE #1”, “SAMPLE #2”, “SAMPLE #3”, “SAMPLE #4”, and “SAMPLE #5”, each having a thickness of 50 μm, were fabricated using the glass substrates and the method of FIG. 7.

The density, glass transition temperature, thermal expansion coefficient, hardness, Poisson's ratio, fracture toughness, brittleness, and modulus of elasticity of the glass articles “SAMPLE #1”, “SAMPLE #2”, “SAMPLE #3”, “SAMPLE #4”, and “SAMPLE #5” were measured, and the results of the measurement are as shown in Table 1 below.

TABLE 1

| Samples | | SAMPLE #1 | SAMPLE #2 | SAMPLE #3 | SAMPLE #4 | SAMPLE #5 |
|---|---|---|---|---|---|---|
| Composition | SiO₂ | 57.5 | 66.7 | 64.9 | 62.1 | 69.5 |
| | Al₂O₃ | 20.0 | 12.4 | 16.4 | 17.7 | 4.7 |
| | B₂O₃ | 2.5 | — | — | 0.4 | — |
| | MgO | — | 4.8 | 3.4 | 2.9 | 8.9 |
| | CaO | — | — | — | — | 1.7 |
| | NaO | 20.0 | 12.5 | 14.8 | 14.1 | 14.8 |
| | K₂O | — | 2.5 | — | 2.1 | 0.3 |
| Al₂O₃:R₂O Composition | | 20.0:20.0 | 12.4:15:0 | 16.4:14.8 | 17.7:16.2 | 4.7:15.1 |
| Ratio (mol %) | | | | | | |
| Al₂O₃/R₂O Composition | | 1.0 | 0.83 | 1.11 | 1.09 | 0.31 |
| Ratio (mol %) | | | | | | |
| Physical | Density | 2.59 | 2.46 | 2.42 | 2.45 | 2.48 |
| Properties | (g/cm³) | | | | | |
| | Glass | 715 | 602 | 642 | 605 | 550 |
| | Transition | | | | | |
| | Temperature | | | | | |
| | Tg (° C.) | | | | | |
| | Thermal | 83 | 89 | 80 | 91 | 91 |
| | Expansion | | | | | |
| | Coefficient | | | | | |
| | (* 10⁻⁷ K⁻¹) | | | | | |
| | Hardness | 525 | 617 | 534 | 590 | 539 |
| | (kgh/mm²) | | | | | |
| | (Unstrengthened) | | | | | |
| | Poisson’s | 0.202 | 0.215 | 0.21 | 0.20 | 0.23 |
| | ratio | | | | | |
| | Fracture | 0.90 | 0.87 | 0.68 | 0.68 | 0.7 |
| | Toughness | | | | | |
| | (MPa * m^{0.5}) | | | | | |
| | Brittleness | 5.72 | 6.56 | 7.85 | 8.68 | 7.70 |
| | (μm^{-0.5}) | | | | | |
| | Modulus of | 71.0 | 72.3 | 71.5 | 70.0 | 73.1 |
| | Elasticity | | | | | |
| | (GPa) | | | | | |

Referring to Table 1, the glass article “SAMPLE #1” was prepared from a glass composition containing 20 mol % of Na₂O (as an alkali metal oxide, i.e., R₂O), but not an alkali earth metal oxide (i.e., RO), and having an Al₂O₃-to-Na₂O content ratio of 1.0, and each of the glass articles “SAMPLE #2”, “SAMPLE #3”, “SAMPLE #4”, and “SAMPLE #5” was prepared from a glass composition containing RO and having an Al₂O₃-to-Na₂O content ratio greater than 1 or less than 1. Specifically, the glass articles “SAMPLE #4” and “SAMPLE #5” have an Al₂O₃-to-Na₂O content ratio of 1.11 and 1.09, respectively.

The glass article “SAMPLE #1” has a relatively high density of 2.5 g/cm³ or greater and a relatively high glass transition temperature of 700° C. or higher. Also, the glass article “SAMPLE #1” has a relatively high thermal expansion coefficient of 83*10⁻⁷ K⁻¹ and a similar modulus of elasticity of 71.0 GPa, as compared to the other glass articles. This means that glass articles having an Al₂O₃-to-Na₂O content ratio (or R ratio) of 1.0 can have both flexibility and excellent strength.

The glass articles “SAMPLE #2”, “SAMPLE #3”, “SAMPLE #4”, and “SAMPLE #5” have a relatively low density of 2.5 g/cm³ or less or a thermal expansion coefficient of 90*10⁻⁷ K⁻¹ or greater. Table 1 shows that glass articles having a glass transition temperature of 700° C. or lower, particularly, about 600° C., and having a high thermal expansion coefficient have low thermal durability.

Specifically, the glass articles “SAMPLE #1” and “SAMPLE #2” have a fracture toughness of 0.90 MPa*m^{0.5} and 0.87 MPa*m^{0.5}, respectively, and a brittleness of 5.72 μm^{-0.5} and 6.56 μm^{-0.5}, respectively. The glass articles “SAMPLE #1” and “SAMPLE #2” have a stronger impact resistance than the other glass articles, which have a fracture toughness of 0.7 MPa*m^{0.5} or less and a brittleness of 7.70 μm^{0.5}.

### Experimental Example 1: Evaluation of Impact Resistance—Pen Drop Test (Pen Diameter: 0.7π)

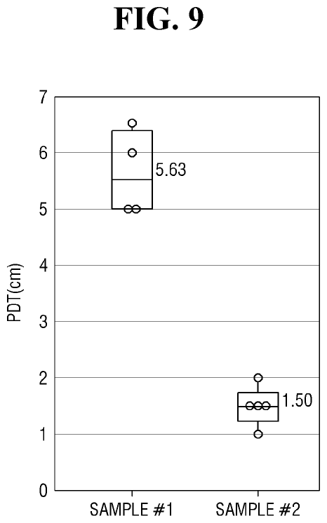

The glass articles “SAMPLE #1” and “SAMPLE #2”, which appear to have a relatively strong impact resistance, among the glass articles listed in Table 1, were subjected to a pen-drop test (“PDT”). The PDT was conducted by repeatedly dropping a pen with a diameter of 0.7π onto each glass article fixed, while changing the drop height of the pen by 0.1 centimeter (cm), within the range of 0.5 cm to 10 cm, and identifying the drop height of the pen that caused a break on the surface of each glass article. The tip of pen which contacts the glass article when the pen drops to the glass has a diameter of 0.7π. The maximum drop height of the pen that did not cause a break was determined as a limit pen-drop height. The results of the PDT are as shown in FIG. 9.

FIG. 9 is a graph showing the results of a pen-drop test for evaluating the impact resistance of the glass article according to an embodiment of the disclosure.

Referring to FIG. 9, the median limit pen-drop height of the glass article “SAMPLE #1” was measured to be 5.63 cm, and the median limit pen-drop height of the glass article “SAMPLE #2” was measured to be 1.50 cm. As the median limit pen-drop height of the glass article “SAMPLE #1” is much greater than the median limit pen-drop height of the glass article “SAMPLE #2”, the glass article “SAMPLE #1” appears to have an excellent surface strength. The results of a PDT using a pen with a diameter of 0.7n show that the glass article 100 has a median limit pen-drop height of 5 cm or greater. The tip of pen which contacts the glass article when the pen drops to the glass has a diameter of 0.7n.

### Experimental Example 2: Evaluation of Etch Rate

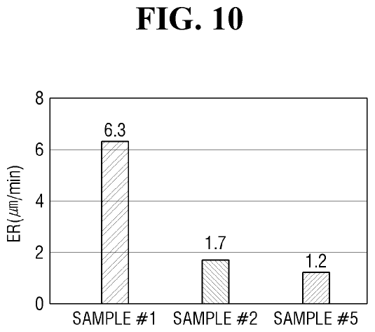

The glass articles “SAMPLE #1”, “SAMPLE #2”, and “SAMPLE #5” were subjected to an etch rate test. The etch rate test was conducted by placing each of the glass articles “SAMPLE #1”, “SAMPLE #2”, and “SAMPLE #5” in a stirrer, pouring a fluoride-based etchant into the stirrer, rotating the stirrer at a speed of 60 rpm, and measuring the amount by which each of the glass articles “SAMPLE #1”, “SAMPLE #2”, and “SAMPLE #5” was etched. Before the stirring of the etchant, the initial thickness of each of the glass articles “SAMPLE #1”, “SAMPLE #2”, and “SAMPLE #5” was measured. Then, the amount by which the thickness of each of the glass articles “SAMPLE #1”, “SAMPLE #2”, and “SAMPLE #5” was reduced was measured while rotating the stirrer for several to dozens of minutes. The etch rate of each of the glass articles “SAMPLE #1”, “SAMPLE #2”, and “SAMPLE #5” was calculated by dividing the amount by which the thickness of each of the glass articles “SAMPLE #1”, “SAMPLE #2”, and “SAMPLE #5” were reduced by the duration for which the stirrer was stirred, and the results of the calculation are as shown in FIG. 10.

FIG. 10 is a graph showing the results of an etch rate test for the glass article according to an embodiment of the disclosure.

Referring to FIG. 10, the etch rate of the glass article “SAMPLE #1” was measured to be 6.3 μm/min, and the etch rate of the glass article “SAMPLE #2” was measured to be 1.7 μm/min. The glass article “SAMPLE #1” has a higher etch rate than the other glass articles, and this means that the glass article “SAMPLE #1” has an excellent processability and moldability, as compared to the other glass articles. The glass article 100 may have an etch rate of 3 or 5 μm/min or greater with respect to an etchant.

In concluding the detailed description, those skilled in the art will appreciate that many variations and modifications can be made to the preferred embodiments without substantially departing from the principles of the invention. Therefore, the disclosed preferred embodiments of the invention are used in a generic and descriptive sense only and not for purposes of limitation.

What is claimed is:

1. A glass article comprising, as a glass composition, about 45 to about 65 molar percentages (mol %) of SiO₂, about 15 to about 25 mol % of Al₂O₃, about 15 to about 25 mol % of Na₂O, and 0 to about 10 mol % of B₂O₃ based on a total weight of the glass composition,
wherein the glass composition has a thermal expansion coefficient of about 70*10⁻⁷ per Kelvin (K⁻¹) to about 85*10⁻⁷ K⁻¹ and satisfies the following relations:
0.8<Al₂O₃/Na₂O<1.2,
where Al₂O₃/Na₂O refers to a ratio between the contents in mol % of Al₂O₃ and Na₂O.

2. The glass article of claim 1, wherein the glass article comprises, as the glass composition, about 55 mol % or greater of SiO₂, about 20 mol % or greater of Na₂O, and about 20 mol % or greater of Al₂O₃ and has Al₂O₃/Na₂O of about 1.0.

3. The glass article of claim 2, wherein the glass article does not comprise an alkali earth metal oxide.

4. The glass article of claim 1, wherein the glass article has a thickness of about 20 micrometers (μm) to about 50 μm.

5. The glass article of claim 4, wherein the glass article has a hardness of about 450 kilogram-force per square millimeter (kgf/mm²) to about 550 kgf/mm².

6. The glass article of claim 4, wherein the glass article has a density of about 2.5 grams per cubic centimeter (g/cm³) to about 2.8 g/cm³.

7. The glass article of claim 4, wherein the glass article has a brittleness of about 4.5 μm^{-0.5} to about 7.0 μm^{-0.5}.

8. The glass article of claim 4, wherein the glass article has a Poisson's ratio of about 0.14 to about 0.25.

9. The glass article of claim 4, wherein the glass article has a glass transition temperature of about 600 degrees in Celsius (° C.) to about 800° C.

10. The glass article of claim 4, wherein the glass article has a modulus of elasticity of about 60 gigapascals (GPa) to about 80 GPa.

11. The glass article of claim 4, wherein the glass article has a fracture toughness of about 0.7 MPa*m^{0.5} to about 1.0 MPa*m^{0.5}.

12. The glass article of claim 1, wherein the glass article has an etch rate of about 3 micrometers per minute (μm/min) to about 7 μm/min.

13. A glass composition comprising about 45 to about 65 mol % of SiO₂, about 15 to about 25 mol % of Al₂O₃, about 15 to about 25 mol % of Na₂O, and 0 to about 10 mol % of B₂O₃ based on a total weight of the glass composition,
wherein the glass composition satisfies the following relations:
0.8<Al₂O₃/Na₂O<1.2
where Al₂O₃/Na₂O refers to a ratio between the contents in mol % of Al₂O₃ and Na₂O.

14. The glass composition of claim 13, wherein the glass composition comprises about 55 mol % or greater of SiO₂, about 20 mol % or greater of Na₂O, and about 20 mol % or greater of Al₂O₃ and has Al₂O₃/Na₂O of 1.0.

15. The glass composition of claim 14, wherein the glass composition comprises about 2.5 to about 5 mol % based on the total weight of the glass composition.

16. The glass composition of claim 14, wherein the glass composition does not comprise an alkali earth metal oxide.

17. The glass composition of claim 14, wherein the glass composition does not comprise R₂O other than Na₂O, and R is Li or K.

18. A display device comprising:
a display panel including a plurality of pixels;
a cover window disposed on the display panel; and
an optically transparent bonding layer disposed between the display panel and the cover window,
wherein the cover window comprises, as a glass composition, about 45 to about 65 mol % of SiO₂, about 15 to about 25 mol % of Al₂O₃, about 15 to about 25 mol % of Na₂O, and 0 to about 10 mol % of B₂O₃ based on a total weight of the glass composition, has a thermal expansion coefficient of about 70*10⁻⁷K⁻¹ to about 85*10⁻⁷K⁻¹, and satisfies the following relations:
0.8<Al₂O₃/Na₂O<1.2
where Al₂O₃/Na₂O refers to a ratio between the contents in mol % of Al₂O₃ and Na₂O.

19. The display device of claim 18, wherein the cover window has a thickness of about 20 μm to about 50 μm.

20. The display device of claim 19, wherein the cover window does not comprise an alkali earth metal oxide.
